(19) United States
(12) Patent Application Publication
(10) Pub. No.: US 2014/0174280 A1
(43) Pub. Date: Jun. 26, 2014

(54) SIGNAL PROCESSING APPARATUS AND METHOD, SIGNAL PROCESSING SYSTEM, AND PROGRAM

(71) Applicants: Shuichiro Nishigori, Tokyo (JP); Akira Inoue, Toky (JP)

(72) Inventors: Shuichiro Nishigori, Tokyo (JP); Akira Inoue, Toky (JP)

(73) Assignee: SONY CORPORATION, Minato-ku, Tokyo (JP)

(21) Appl. No.: 14/236,435

(22) PCT Filed: Aug. 1, 2012
(86) PCT No.: PCT/JP2012/069612

§ 371 Date: Jan. 31, 2014

(30) Foreign Application Priority Data
Oct. 8, 2011 (JP) 2011-174934

(51) Int. Cl. G10K 15/04

(52) U.S. Cl. CPC G10K 15/04
USPC 84/622

(57) ABSTRACT

A signal processing apparatus and method, a signal processing system, and a program designed to appropriately set harmonizing periods in accordance with a status of singing of a performer and add a harmonizing voice. A singing enthusiasm calculating unit calculates a degree of singing enthusiasm formed with a feature quantity indicating the status of singing enthusiasm of a performer of a tune. A harmonizing signal controlling unit determines whether to superimpose a harmonizing voice signal generated by a pitch detecting unit, a harmonizing key determining unit, and a pitch shifter on the singing voice signal of the performer of the tune based on the degree of singing enthusiasm calculated by the singing enthusiasm calculating unit, and superimposes the harmonizing voice signal on the singing voice signal based on a result of the determination. The technique can be applied to karaoke machines.

### TECHNICAL FIELD

The present technique relates to signal processing apparatuses and methods, signal processing systems, and programs, and more particularly, to a signal processing apparatus and method, a signal processing system, and a program that are designed to appropriately add a harmonizing voice when a person sings with an accompaniment played by a karaoke machine or the like.

### BACKGROUND ART

Karaoke machines are widely used these days, and there are a wide variety of them ranging from online karaoke machines installed in karaoke bars to simple karaoke functions to be executed by mobile devices. A karaoke machine is an apparatus that reproduces recorded accompaniment music instead of providing live music, and allows a person to sing with an accompaniment or play a melody line (a main theme) on an instrument along with an accompaniment. Also, such an act may sometimes be referred to as karaoke.

It is known that a conventional karaoke machine has a function (hereinafter referred to as a harmonizing function) to add a sound (hereinafter referred to as a harmonizing sound) consonant with a singing voice (hereinafter referred to as a vocalized sound) of a user to the vocalized sound (see Patent Document 1). This function generates a harmonizing sound formed with a sound that is above or below a vocalized sound input through a microphone by a certain interval (the third in a musical scale, for example), and adds the harmonizing sound to the original vocalized sound. In this manner, the harmonizing function is realized. Other than this method, there are a number of methods developed for creating more beautiful harmonies.

### CITATION LIST

### Patent Document

Patent Document 1: JP 8-50493 A

### SUMMARY OF THE INVENTION

### Problems to be Solved by the Invention

However, harmonizing sound adding periods are not automatically set, and need to be set manually. In a case where a performer needs to determine whether to enable or disable the harmonizing function each time, for example, the performer has to determine the time to do so while singing with an accompaniment played by a karaoke machine. Therefore, there is a possibility that the performer cannot really enjoy singing with an accompaniment played by the karaoke machine.

In a case where harmonizing sound adding periods are set for each tune beforehand by a karaoke music distributor, the work to set the harmonizing sound adding periods leads to higher costs. Furthermore, if a harmonizing sound is added to an entire tune from the top to the bottom, the performer might find singing the tune monotonous and boring.

The present technique has been developed in view of those circumstances, and an object thereof is to provide a karaoke machine that can output a wide variety of enjoyable accompaniments by appropriately controlling harmonizing sound adding periods in accordance with each tune and the way of singing of each performer, cut the cost of setting harmonizing sound adding periods in advance, and save each performer from the trouble of operating the harmonizing function.

### Solutions to Problems

A signal processing apparatus of one aspect of the present technique includes: a singing enthusiasm calculating unit that calculates a degree of singing enthusiasm formed with a feature quantity indicating the status of singing enthusiasm of a performer of a tune; a harmonizing voice signal superimposition determining unit that determines whether to superimpose a harmonizing voice signal on a singing voice signal of the performer of the tune based on the degree of singing enthusiasm calculated by the singing enthusiasm calculating unit; and a harmonizing voice signal superimposing unit that superimposes the harmonizing voice signal on the singing voice signal based on a result of the determination performed by the harmonizing voice signal superimposition determining unit.

The singing enthusiasm calculating unit may be designed to calculate the degree of singing enthusiasm formed with the feature quantity indicating the status of singing enthusiasm of the performer based on a singing voice signal of the performer of the tune.

The signal processing apparatus may further include a biological information acquiring unit that acquires biological information about the performer. The singing enthusiasm calculating unit may be designed to calculate the degree of singing enthusiasm formed with the feature quantity indicating the status of singing enthusiasm of the performer based on the biological information about the performer of the tune.

The harmonizing voice signal superimposition determining unit may be designed to determine whether to superimpose the harmonizing voice signal on the singing voice signal of the performer of the tune by comparing the degree of singing enthusiasm calculated by the singing enthusiasm calculating unit with a singing enthusiasm threshold value that is set with respect to the degree of singing enthusiasm, and determine that the harmonizing voice signal is to be superimposed on the singing voice signal of the performer of the tune when the degree of singing enthusiasm is higher than the singing enthusiasm threshold value.

The signal processing apparatus may further include an excitement calculating unit that calculates a degree of excitement of the tune based on a music audio signal that is the audio signal of the tune. The harmonizing voice signal superimposition determining unit may be designed to determine whether to superimpose the harmonizing voice signal on the singing voice signal based on the degree of singing enthusiasm calculated by the singing enthusiasm calculating unit and the degree of excitement calculated by the excitement calculating unit.

The singing enthusiasm threshold calculating unit may be designed to calculate a singing enthusiasm threshold value by using the average value of the degrees of singing enthusiasm of performers. The harmonizing voice signal superimposition determining unit may be designed to determine whether to superimpose the harmonizing voice signal on the singing voice signal of the performer of the tune by comparing the degree of singing enthusiasm calculated by the singing enthusiasm calculating unit with the singing enthusiasm threshold value that is set with respect to the degree of singing enthusiasm and is determined by using the average value of the degrees of singing enthusiasm of the performers, and determine that the harmonizing voice signal is to be superimposed on the singing voice signal of the performer of the tune when the degree of singing enthusiasm is higher than the singing enthusiasm threshold value.

A signal processing system of the present technique includes: an information processing apparatus that includes: a singing enthusiasm acquiring unit that acquires degrees of singing enthusiasm calculated by singing enthusiasm calculating units from signal processing apparatuses of any of claims 1 through 6 via a network, the signal processing apparatuses including the respective singing enthusiasm calculating units that calculate the degrees of singing enthusiasm; a singing enthusiasm threshold calculating unit that calculates a singing enthusiasm threshold value by using the average value of the degrees of singing enthusiasm obtained by the singing enthusiasm acquiring unit from the signal processing apparatuses; and a delivering unit that delivers the singing enthusiasm threshold value calculated by the singing enthusiasm threshold calculating unit to the signal processing apparatuses; and the signal processing apparatus of any of claims 1 through 6. The harmonizing voice signal superimposition determining unit may be designed to determine whether to superimpose the harmonizing voice signal on the singing voice signal of the performer of the tune by comparing the degree of singing enthusiasm calculated by the singing enthusiasm calculating unit with the singing enthusiasm threshold value that is set with respect to the degree of singing enthusiasm and is delivered from the delivering unit, and determine that the harmonizing voice signal is to be superimposed on the singing voice signal of the performer of the tune when the degree of singing enthusiasm is higher than the singing enthusiasm threshold value.

A signal processing method of one aspect of the present technique includes: a singing enthusiasm calculating step of calculating a degree of singing enthusiasm formed with a feature quantity indicating the status of singing enthusiasm of a performer of a tune, the singing enthusiasm calculating step being carried out at a singing enthusiasm calculating unit that calculates the degree of singing enthusiasm formed with the feature quantity indicating the status of singing enthusiasm of the performer of the tune; a harmonizing voice signal superimposition determining step of determining whether to superimpose a harmonizing voice signal on a singing voice signal of the performer of the tune based on the degree of singing enthusiasm calculated by the processing in the singing enthusiasm calculating step, the harmonizing voice signal superimposition determining step being carried out at a harmonizing voice signal superimposition determining unit that determines whether to superimpose the harmonizing voice signal on the singing voice signal of the performer of the tune based on the degree of singing enthusiasm calculated by the singing enthusiasm calculating unit; and a harmonizing voice signal superimposing step of superimposing the harmonizing voice signal on the singing voice signal based on a result of the determination performed by the processing in the harmonizing voice signal superimposition determining step, the harmonizing voice signal superimposing step being carried out at a harmonizing voice signal superimposing unit that superimposes the harmonizing voice signal on the singing voice signal based on a result of the determination performed by the harmonizing voice signal superimposition determining unit.

A program of one aspect of the present technique causes a computer to perform an operation that includes: a singing enthusiasm calculating step of calculating a degree of singing enthusiasm formed with a feature quantity indicating the status of singing enthusiasm of a performer of a tune, the singing enthusiasm calculating step being carried out at a singing enthusiasm calculating unit; a harmonizing voice signal superimposition determining step of determining whether to superimpose a harmonizing voice signal on a singing voice signal of the performer of the tune based on the degree of singing enthusiasm calculated by the processing in the singing enthusiasm calculating step, the harmonizing voice signal superimposition determining step being carried out at a harmonizing voice signal superimposition determining unit; and a harmonizing voice signal superimposing step of superimposing the harmonizing voice signal on the singing voice signal based on a result of the determination performed by the processing in the harmonizing voice signal superimposition determining step, the harmonizing voice signal superimposing step being carried out at a harmonizing voice signal superimposing unit, the computer controlling a signal processing apparatus that includes: the singing enthusiasm calculating unit that calculates the degree of singing enthusiasm formed with the feature quantity indicating the status of singing enthusiasm of the performer of the tune; the harmonizing voice signal superimposition determining unit that determines whether to superimpose the harmonizing voice signal on the singing voice signal of the performer of the tune based on the degree of singing enthusiasm calculated by the singing enthusiasm calculating unit; and the harmonizing voice signal superimposing unit that superimposes the harmonizing voice signal on the singing voice signal based on a result of the determination performed by the harmonizing voice signal superimposition determining unit.

In one aspect of the present technique, a degree of singing enthusiasm formed with a feature quantity indicating the status of singing enthusiasm of a performer of a tune is calculated, a check is made to determine whether to superimpose a harmonizing voice signal on a singing voice signal of the performer of the tune based on the calculated degree of singing enthusiasm, and the harmonizing voice signal is superimposed on the singing voice signal based on a result of the determination.

A signal processing apparatus of the present technique may be an independent apparatus, or may be a block that performs signal processing.

### Effects of the Invention

According to the present technique, appropriate harmonizing sound adding periods can be set in accordance with each tune and the way of singing of each performer.

### BRIEF DESCRIPTION OF DRAWINGS

FIG. 1 is a diagram showing an example structure of an embodiment of a signal processing system in which signal processing apparatuses of the present technique are used.

FIG. 2 is a diagram for explaining an example structure of a voice processing apparatus.

FIG. 3 is a diagram for explaining an example structure of the DSP.

FIG. 4 is a diagram for explaining an example structure of the harmonizing signal controlling unit.

FIG. 5 is a diagram for explaining an example structure of the singing enthusiasm server.

FIG. 6 is a flowchart for explaining a playing process.

FIG. 7 is a flowchart for explaining a harmony control process.

FIG. 8 is a flowchart for explaining a singing enthusiasm calculation process.

FIG. 9 is a flowchart for explaining a musical excitement calculation process.

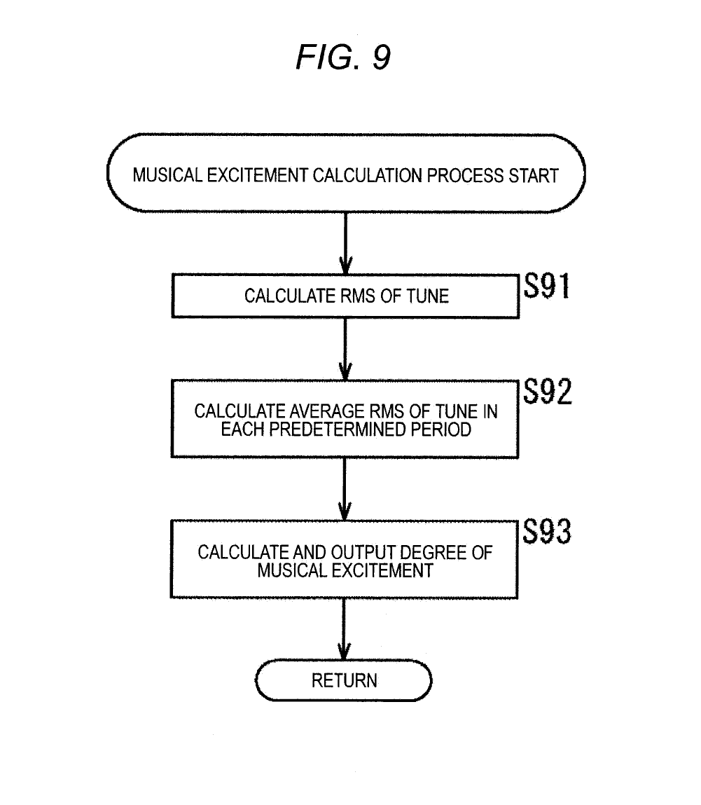

FIG. 10 is a diagram for explaining a calculation of a degree of singing enthusiasm.

FIG. 11 is a diagram for explaining an example structure of a general-purpose personal computer.

### MODES FOR CARRYING OUT THE INVENTION

### Example Structure of a Signal Processing System to Which the Present Technique Is Applied

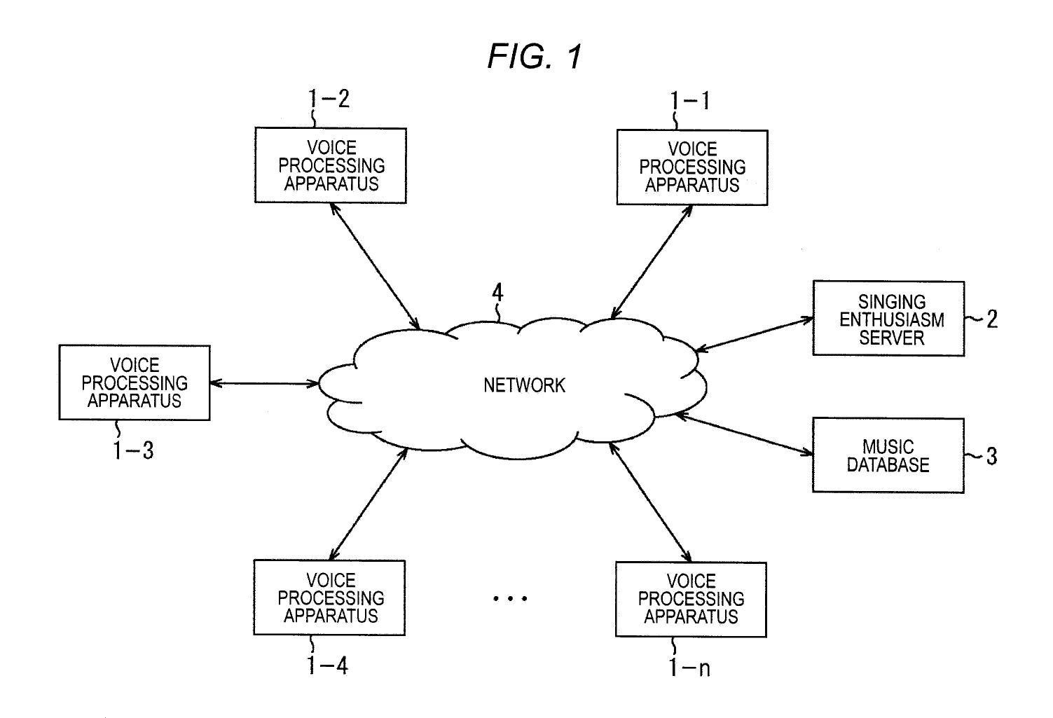

Referring to FIG. 1, an example structure of a signal processing system to which the present technique is applied is described.

The signal processing system shown in FIG. 1 includes voice processing apparatuses 1-1 through 1-n each formed with a karaoke machine that can perform communication via a so-called network 4 and is installed in a karaoke bar, a singing enthusiasm server 2, and a music database 3. It should be noted that the voice processing apparatuses 1-1 through 1-n will be hereinafter referred to simply as the voice processing apparatuses 1 as long as there is no particular need to distinguish those apparatuses from one another. The same applies to the other structures.

Each voice processing apparatus 1 is a karaoke machine that is installed in a so-called karaoke bar or the like, and, when an operation instruction is issued from a performer (not shown), downloads and plays the audio data of the designated tune from the music database 3 via the network 4 such as the Internet. Based on a singing voice signal generated from the performer singing, the voice processing apparatus 1 calculates a degree of singing enthusiasm, adds (superimposes) a harmonizing voice (a harmonizing sound) to (on) the singing voice signal (a vocal sound) in accordance with the calculated degree of singing enthusiasm, outputs the singing voice signal having the harmonizing voice added thereto, and supplies information about the calculated degree of singing enthusiasm to the singing enthusiasm server 2 via the network 4. Having obtained information about degrees of singing enthusiasm supplied from the voice processing apparatuses 1 via the network 4, the singing enthusiasm server 2 calculates the average degree of singing enthusiasm of each tune, and stores a singing enthusiasm threshold value that is such an offset value as to lower the average value by a predetermined value. The singing enthusiasm server 2 delivers the stored information about the singing enthusiasm threshold value to a voice processing apparatus 1 via the network 4 when the voice processing apparatus 1 downloads the audio data of the tune from the music database 3. Based on a comparison between the degree of singing enthusiasm determined from the singing voice signal of the performer and the singing enthusiasm threshold value obtained via the network 4, the voice processing apparatus 1 determines intervals at which a harmonizing voice is to be added, and superimposes the harmonizing voice on the singing voice signal. The music database 3 accumulates designated music data. Hereinafter, the action to superimpose a harmonizing voice that is a consonant sound on a singing voice signal will be referred to as “harmonizing”, “adding a harmonizing voice”, or “switching on the harmonizing function”.

[Example Structure of a Voice Processing Apparatus]

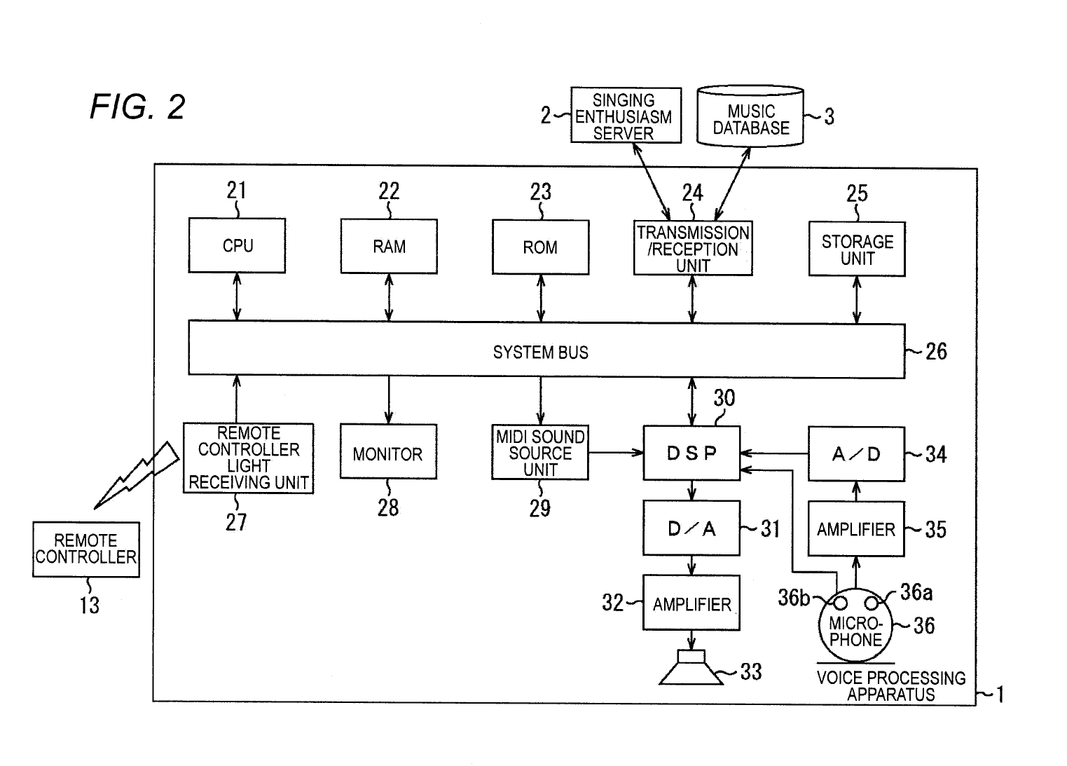

Referring now to FIG. 2, an example structure of a voice processing apparatus 1 is described.

The voice processing apparatus 1 includes a CPU (Central Processing Unit) 21, a RAM (Random Access Memory) 22, a ROM (Read Only Memory) 23, a transmission/reception unit 24, a storage unit 25, a system bus 26, a remote controller light receiving unit 27, and a monitor 28. The voice processing apparatus 1 also includes a MIDI (Musical Instrument Digital Interface) sound source unit 29, a DSP (Digital Signal Processor) 30, a D/A (Digital-Analog) converter 31, and an amplifier 32. The voice processing apparatus 1 further includes a speaker 33, an A/D (Analog-Digital) converter 34, an amplifier 35, and a microphone 36.

The CPU 21 reads a predetermined program and data that are stored beforehand in the ROM 23 or the storage unit 25 formed with an HDD (Hard Disk Drive) or an SSD (Solid State Drive) via the system bus 26, loads the predetermined program and the data into the RAM 22, and performs predetermined processes. The CPU 21 controls the entire operation of the voice processing apparatus 1 by performing the series of processes.

The transmission/reception unit 24 is a so-called Ethernet (a registered trademark) board or the like that downloads a tune from the music database 3 via the network 4, and uploads information about a degree of singing enthusiasm calculated by the DSP 30 based on a singing voice signal of a performer to the singing enthusiasm server 2.

The storage unit 25 is formed with an HDD or an SSD or the like that is controlled by the CPU 21. The storage unit 25 stores data and programs necessary for performing processing, and also stores downloaded music data. The storage unit 25 supplies the downloaded music data to the CPU 21, the MIDI sound source unit 29, and the DSP 30 via the system bus 26.

The remote controller light receiving unit 27 receives a signal generated as an infrared ray by the remote controller 13 for operating the voice processing apparatus 1, converts the signal into a predetermined signal, and supplies the converted signal to the CPU 21 via the system bus 26.

The monitor 28 is formed with an LCD (Liquid Crystal Display), an organic EL (Electronic Luminescent), or the like, is controlled by the CPU 21, and displays various kinds of information and processing results.

The MIDI sound source unit 29 converts music data in the MIDI format downloaded by the transmission/reception unit 24 from the music database 3 via the network 4 into a digital signal that can be processed by the DSP 30, and outputs the digital signal to the DSP 30.

The microphone 36 is held by a performer, collects a singing voice emitted from the performer, and supplies the singing voice as an analog signal to the amplifier 35. In the microphone 36, sensors 36a and 36b are provided at portions to be touched by the performer to hold the main body, the sensors 36a and 36b measure a pulse rate and a body temperature of the performer, and supply the pulse rate and the body temperature to the DSP 30. The amplifier 35 amplifies the analog signal formed with the singing voice signal supplied from the microphone 36 by a predetermined amplification factor, and supplies the amplified analog signal to the A/D converter 34. The A/D converter 34 converts the singing voice signal formed with the analog signal amplified by a predetermined amplification factor by the amplifier 35 into a digital signal that can be processed by the DSP 30, and supplies the digital signal.

The DSP 30 is controlled by the CPU 21 via the system bus 26, adds a harmonizing voice and an echo effect to a tune formed with the digital signal from the MIDI sound source unit 29 and to the singing voice signal formed with the digital signal supplied from the A/D converter 34 through a predetermined process, and outputs the resultant signal to the D/A converter 31. The D/A converter 31 converts the voice signal formed with the digital signal subjected to various kinds of processes by the DSP 30 into an analog signal, and supplies the analog signal to the amplifier 32. The amplifier 32 amplifies the voice signal converted into the analog signal by a predetermined amplification factor, and outputs the resultant signal as a voice through the speaker 33.

[Example Structure of the DSP]

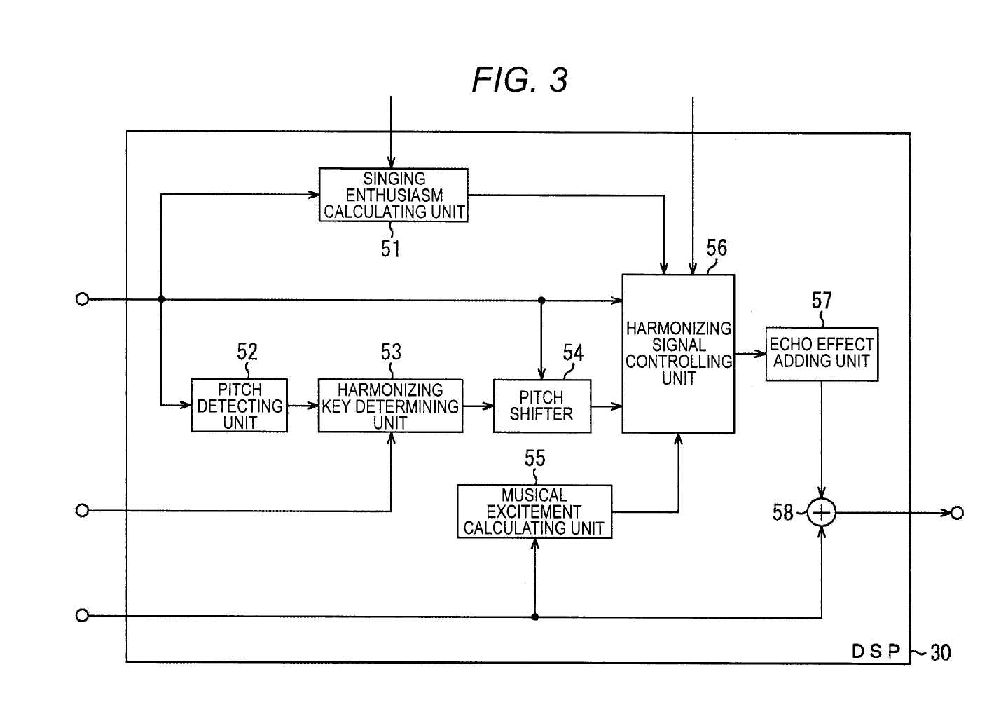

Referring now to FIG. 3, an example structure of the DSP 30 is described.

The DSP 30 includes a singing enthusiasm calculating unit 51, a pitch detecting unit 52, a harmonizing key determining unit 53, a pitch shifter 54, a musical excitement calculating unit 55, a harmonizing signal controlling unit 56, an echo effect adding unit 57, and an adder 58.

Based on the singing voice signal supplied from the A/D converter 34 and the information about the pulse rate and the body temperature of the performer supplied from the microphone 36, the singing enthusiasm calculating unit 51 chronologically calculates a degree of singing enthusiasm, stores the degree of singing enthusiasm into an internal storage unit 51a, and supplies the degree of singing enthusiasm to the harmonizing signal controlling unit 56. When the supply of music data is completed, and the playing is ended, the singing enthusiasm calculating unit 51 controls the transmission/reception unit 24 to transmit the information about the degree of singing enthusiasm stored chronologically in the storage unit 51a and information identifying the music data to the singing enthusiasm server 2.

The pitch detecting unit 52 detects the pitch or the fundamental frequency of the singing voice signal supplied from the A/D converter 34, converts the fundamental frequency into pitch notations (sol-fa names), and supplies the pitch notations to the harmonizing key determining unit 53. The harmonizing key determining unit 53 acquires scale and chord information from music data stored in the storage unit 25 via the system bus 26, determines the key to harmonize with the current pitch notation (a harmonizing key that is higher or lower by the third or the fifth) based on the information, and supplies the harmonizing key to the pitch shifter 54. The pitch shifter 54 shifts the singing voice signal by the degrees in accordance with the harmonizing key, to generate and supply a harmonizing voice signal to the harmonizing signal controlling unit 56.

Based on music data supplied from the MIDI sound source unit 29, the musical excitement calculating unit 55 calculates a degree of musical excitement, and supplies the degree of musical excitement to the harmonizing signal controlling unit 56.

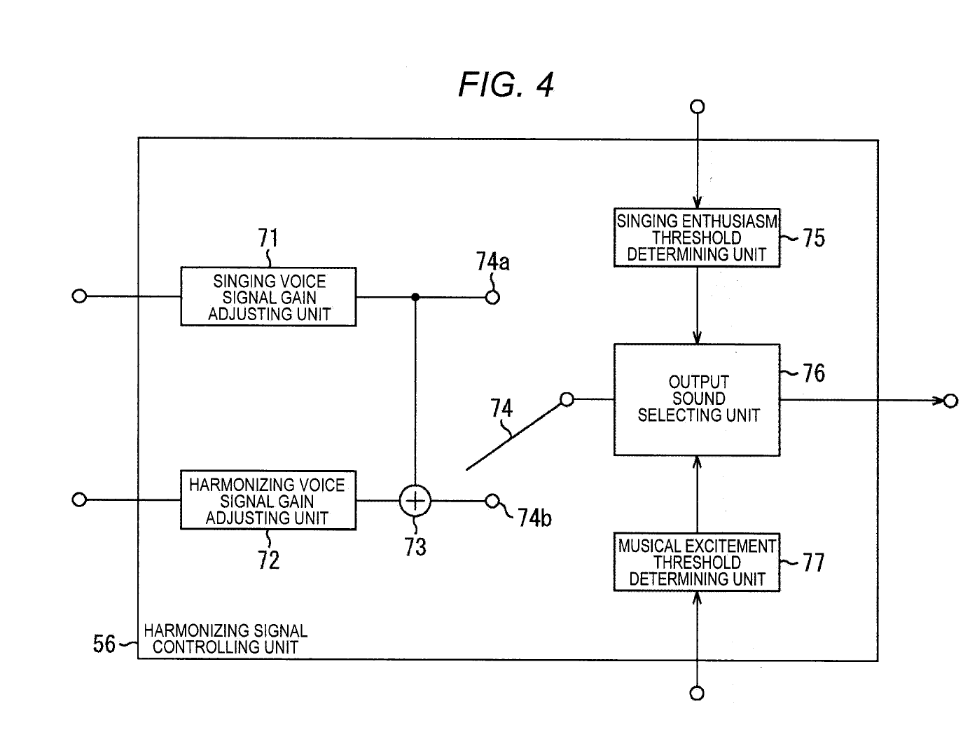

Based on the degree of singing enthusiasm supplied from the singing enthusiasm calculating unit 51 and the degree of musical excitement supplied from the musical excitement calculating unit 55, the harmonizing signal controlling unit 56 performs control to output the singing voice signal as it is or to output the singing voice signal having the harmonizing voice signal added thereto. The structure of the harmonizing signal controlling unit 56 will be described later in detail, with reference to FIG. 4.

The echo effect adding unit 57 adds an echo effect to the singing voice signal output from the harmonizing signal controlling unit 56 or to the singing voice signal having the harmonizing voice signal added thereto, and supplies the resultant signal to the adder 58.

The adder 58 adds the audio signal of the tune supplied from the MIDI sound source unit 29 to the singing voice signal supplied from the echo effect adding unit 57 or to the singing voice signal having the harmonizing voice added thereto, and output the combined signals.

[Example Structure of the Harmonizing Signal Controlling Unit]

Referring now to FIG. 4, an example structure of the harmonizing signal controlling unit 56 is described.

The harmonizing signal controlling unit 56 includes a singing voice signal gain adjusting unit 71, a harmonizing voice signal gain adjusting unit 72, an adder 73, a switch 74, a singing enthusiasm threshold determining unit 75, an output sound selecting unit 76, and a musical excitement threshold determining unit 77.

The singing voice signal gain adjusting unit 71 adjusts the gain of the singing voice signal, and outputs the resultant signal to the adder 73 and a terminal 74a of the switch 74. The harmonizing voice signal gain adjusting unit 72 adjusts the gain of the harmonizing voice signal, and outputs the resultant signal to the adder 73. The adder 73 adds and combines (superimposes) the singing voice signal and the harmonizing voice signal having the gains adjusted, and outputs the resultant signal to a terminal 74b of the switch 74.

The singing enthusiasm threshold determining unit 75 controls the transmission/reception unit 24 to obtain a singing enthusiasm threshold value from the singing enthusiasm server 2, compares the singing enthusiasm threshold value with the degree of singing enthusiasm supplied from the singing enthusiasm calculating unit 51, and outputs the comparison result to the output sound selecting unit 76. The musical excitement threshold determining unit 77 compares a musical excitement threshold value with the degree of musical excitement supplied from the musical excitement calculating unit 55, and supplies the comparison result to the output sound selecting unit 76.

Based on the respective comparison results supplied from the singing enthusiasm threshold determining unit 75 and the musical excitement threshold determining unit 77, the output sound selecting unit 76 controls the switch 74 to connect to the terminal 74a or the 74b. As a result, the output sound selecting unit 76 controls the switch 74 to connect to the terminal 74a and outputs the singing voice signal, or controls the switch 74 to connect to the terminal 74b and outputs the singing voice signal combined with the harmonizing voice signal (or having the harmonizing voice signal superimposed thereon).

[Example Structure of the Singing Enthusiasm Server]

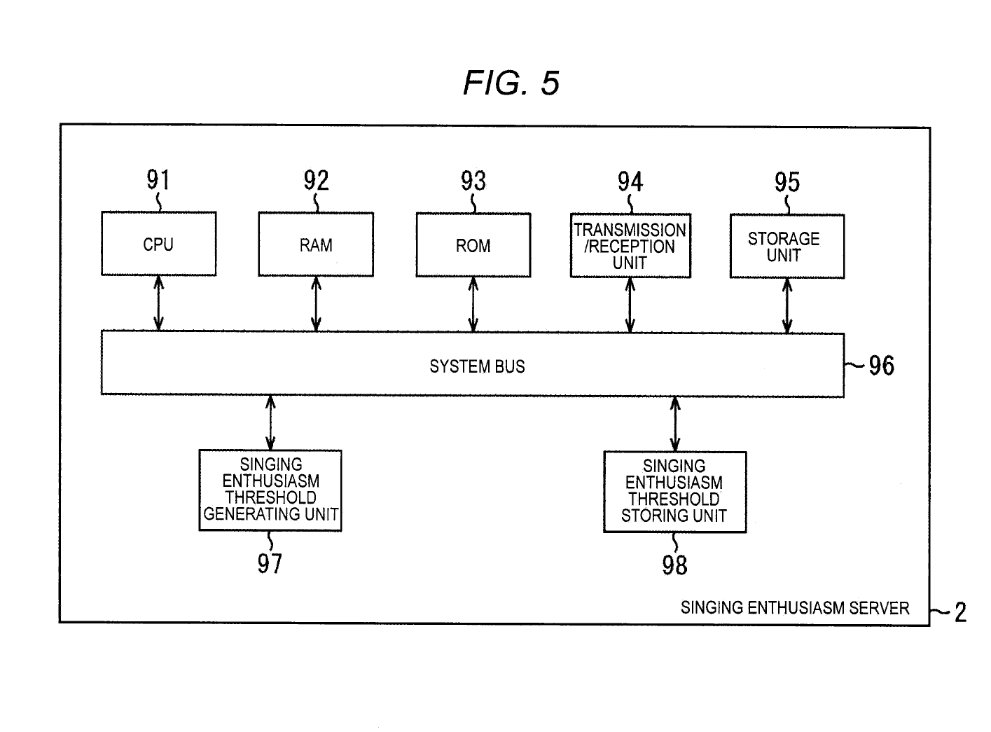

Referring now to FIG. 5, an example structure of the singing enthusiasm server 2 is described.

The singing enthusiasm server 2 includes a CPU 91, a RAM 92, a ROM 93, a transmission/reception unit 94, a storage unit 95, a system bus 96, a singing enthusiasm threshold generating unit 97, and a singing enthusiasm threshold storage unit 98. The CPU 91 reads a predetermined program and data that are stored beforehand in the ROM 93 or the storage unit 95 formed with an HDD or an SSD via the system bus 96, loads the predetermined program and the data into the RAM 92, and performs predetermined processes. The CPU 91 controls the entire operation of the singing enthusiasm server 2 by performing the series of processes.

The transmission/reception unit 94 is a so-called Ethernet (a registered trademark) board, obtains singing enthusiasm information about each tune from the voice processing apparatuses 1 that are karaoke machines via the network 4, and stores the information into the storage unit 95. The transmission/reception unit 94 reads the singing enthusiasm threshold value stored in the singing enthusiasm threshold storage unit 98, and delivers the singing enthusiasm threshold value to the voice processing apparatuses 1.

When new singing enthusiasm information associated with a tune is stored into the storage unit 95, the singing enthusiasm threshold generating unit 97 calculates the average value of the degree of singing enthusiasm of the tune, and offsets the average degree of singing enthusiasm by a predetermined value or a predetermined proportion, to generate the singing enthusiasm threshold value. The singing enthusiasm threshold generating unit 97 then stores the information about the generated singing enthusiasm threshold value associated with the tune into the singing enthusiasm threshold storage unit 98.

[Playing Process]

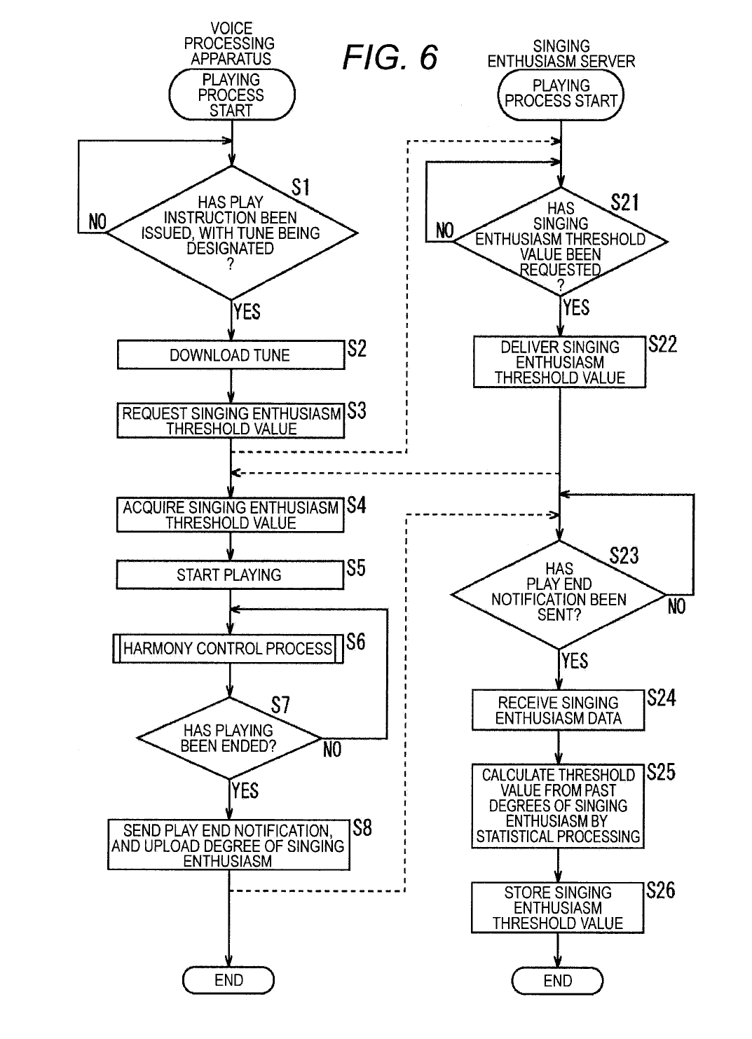

Referring now to the flowchart in FIG. 6, a playing process is described.

In step S1, the CPU 21 determines whether a tune has been designated by operating the remote controller 13 and a play instruction signal has been received by the remote controller light receiving unit 27, and repeats this procedure until determining that light has been received. If a tune has been designed by a user operating the remote controller 13, for example, and a play instruction signal has been issued and been received by the remote controller light receiving unit 27 in step S1, the process moves on to step S2.

In step S2, the CPU 21 controls the transmission/reception unit 24 to download the designated music data from the music database 3 via the network 4, and stores the downloaded music data into the storage unit 25.

In step S3, the CPU 21 instructs the DSP 30 to download the singing enthusiasm threshold value corresponding to the downloaded tune from the singing enthusiasm server 2 via the network 4. In response to this instruction, the harmonizing signal controlling unit 56 of the DSP 30 controls the transmission/reception unit 24 via the system bus 26, and requests the singing enthusiasm threshold value corresponding to the downloaded music data from the singing enthusiasm server 2 via the network 4.

In step S21, the CPU 91 of the singing enthusiasm server 2 controls the transmission/reception unit 94, and determines whether a request for the singing enthusiasm threshold value has been issued, and repeats the same procedure until such a request is made. If it is determined in step S21 that the singing enthusiasm threshold value has been requested by the processing in step S3, the process moves on to step S22.

In step S22, the CPU 91 reads the information about the singing enthusiasm threshold value corresponding to the music data downloaded by a voice processing apparatus 1 among the singing enthusiasm threshold value information stored in the singing enthusiasm threshold storage unit 98. The CPU 91 then controls the transmission/reception unit 94 to transmit the read information about the singing enthusiasm threshold value to the voice processing apparatus 1 that has made the request via the network 4.

In step S4, the DSP 30 controls the transmission/reception unit 24 to obtain the singing enthusiasm threshold value information transmitted from the singing enthusiasm server 2, and stores the information into the singing enthusiasm threshold determining unit 75.

In step S5, the MIDI sound source unit 29 reads the music data in the MIDI format stored in the storage unit 25, converts the music data into a digital audio signal that can be reproduced by the DSP 30, and supplies the digital audio signal. Based on the digital audio signal supplied sequentially from the MIDI sound source unit 29, the DSP 30 reproduces the audio signal of the tune, and causes the D/A converter 31 to convert the audio signal into an analog signal. The amplifier 32 amplifies the analog signal by a predetermined amplification factor, and the amplified analog signal is output through the speaker 33, to start the playing. In response to that, the performer starts singing with the accompaniment music output through the speaker 33 while holding the microphone 36. The sensors 36a and 36b of the microphone 36 measure the pulse rate of the performer and the body temperature of the performer, respectively, and supplies the biological information to the DSP 30.

In step S6, the DSP 30 performs a harmony control process based on the singing voice signal of the performer that is input through the microphone 36, adds (superimposes) a harmonizing voice signal to (on) the singing voice signal if necessary, and outputs the voice through the speaker 33.

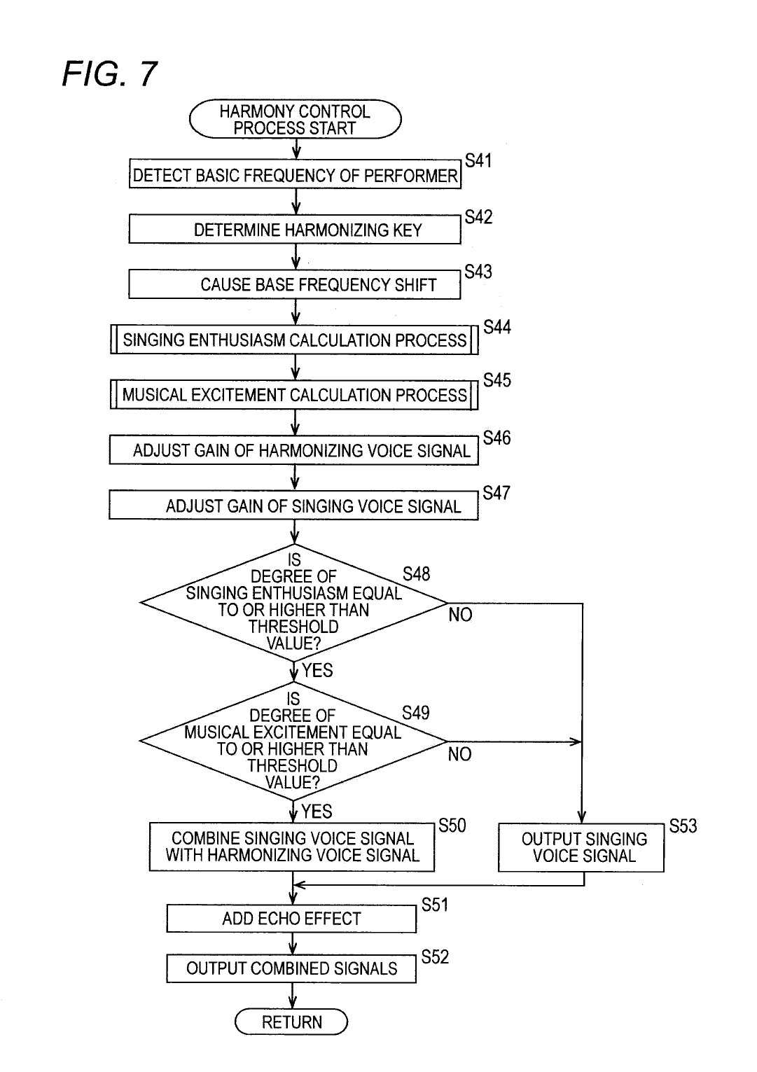

In step S7, the DSP 30 determines whether the playing has been ended or whether the supply of the music data from the MIDI sound source unit 29 has been stopped. If the playing has not been ended yet, the process returns to step S6. Specifically, the DSP 30 continues to perform the harmony control process until the playing is ended, and repeats the step of adding a harmonizing voice signal to the singing voice signal if necessary. At this point, the DSP 30 continues to chronologically calculate a degree of singing enthusiasm and a degree of musical excitement, and stores the result of the singing enthusiasm calculation. It should be noted that the harmony control process will be described later in detail, with reference to the flowchart in FIG. 7.

If it is determined in step S7 that the playing has been ended, for example, the process moves on to step S8.

In step S8, the singing enthusiasm calculating unit 51 of the DSP 30 controls the transmission/reception unit 24 to upload the singing enthusiasm information stored chronologically in the storage unit 51a, together with the information identifying the music data and the information indicating the end of play, to the singing enthusiasm server 2.

Meanwhile, in the singing enthusiasm server 2, after the singing enthusiasm threshold information is transmitted by the processing in step S22, the singing enthusiasm threshold generating unit 97 in step S23 controls the transmission/reception unit 94 and determines whether the information indicating the end of play has been transmitted from the voice processing apparatus 1. In step S23, the same procedure is repeated until it is determined that the information indicating the end of play has been transmitted. If it is determined in step S23 that the information indicating the end of play has been transmitted by the processing in step S8, for example, the process moves on to step S24.

In step S24, the singing enthusiasm threshold generating unit 97 controls the transmission/reception unit 94 to obtain the information identifying the tune and the singing enthusiasm information about the tune transmitted together with the information indicating the end of play, and stores the information into the storage unit 95.

In step S25, the singing enthusiasm threshold generating unit 97 reads the singing enthusiasm information corresponding to the obtained tune among the singing enthusiasm information stored in the storage unit 95, processes the information statistically, and calculates the singing enthusiasm threshold value. More specifically, the singing enthusiasm threshold generating unit 97 calculates the average degree of singing enthusiasm corresponding to the obtained tune among the singing enthusiasm information stored in the storage unit 95, and calculates the singing enthusiasm threshold value that is the chronological information generated by reducing the average value by an offset value.

In step S26, the singing enthusiasm threshold generating unit 97 rewrites and updates the information stored in the singing enthusiasm threshold storage unit 98 with the calculated singing enthusiasm threshold value, and saves (stores) the updated information.

In the above described process, when a tune is designated and a play start instruction is issued in the voice processing apparatus 1, the singing enthusiasm threshold information is downloaded from the singing enthusiasm server 2, the music data is downloaded from the music database 3, and the playing is started. In the voice processing apparatus 1, a harmony control process is performed based on the singing enthusiasm threshold information, and a harmonizing voice signal is added to the singing voice signal of the performer if necessary while the tune is played. When the playing is ended, the information about the degree of singing enthusiasm chronologically calculated based on the singing voice signal of the performer is uploaded to the singing enthusiasm server 2, and the singing enthusiasm threshold value is statistically calculated and updated each time.

[Harmony Control Process]

Referring now to the flowchart in FIG. 7, the harmony control process is described.

In step S41, the pitch detecting unit 52 of the DSP 30 detects pitch that is the fundamental frequency of the singing voice signal of the performer based on the performer's singing voice signal input from the microphone 36 via the amplifier 35 and the A/D converter 34. The pitch detecting unit 52 further converts the detected pitch into pitch notations that are sol-fa names, and supplies the information about the pitch notations to the harmonizing key determining unit 53.

In step S42, the harmonizing key determining unit 53 acquires scale and chord information from music data stored in the storage unit 25 via the system bus 26, and determines the key to harmonize with the current pitch notation (a harmonizing key) based on the information. The harmonizing key determining unit 53 supplies the information about the determined harmonizing key to the pitch shifter 54.

In step S43, the pitch shifter 54 shifts the fundamental frequency of the singing voice signal based on the harmonizing key information supplied from the harmonizing key determining unit 53, to generate and supply the harmonizing voice signal to the harmonizing signal controlling unit 56.

In step S44, the singing enthusiasm calculating unit 51 performs a singing enthusiasm calculation process based on the singing voice signal and the pulse rate and body temperature information supplied from the microphone 36, chronologically calculates a degree of singing enthusiasm, and sequentially stores the degree of singing enthusiasm into the storage unit 51a.

[Singing Enthusiasm Calculation Process]

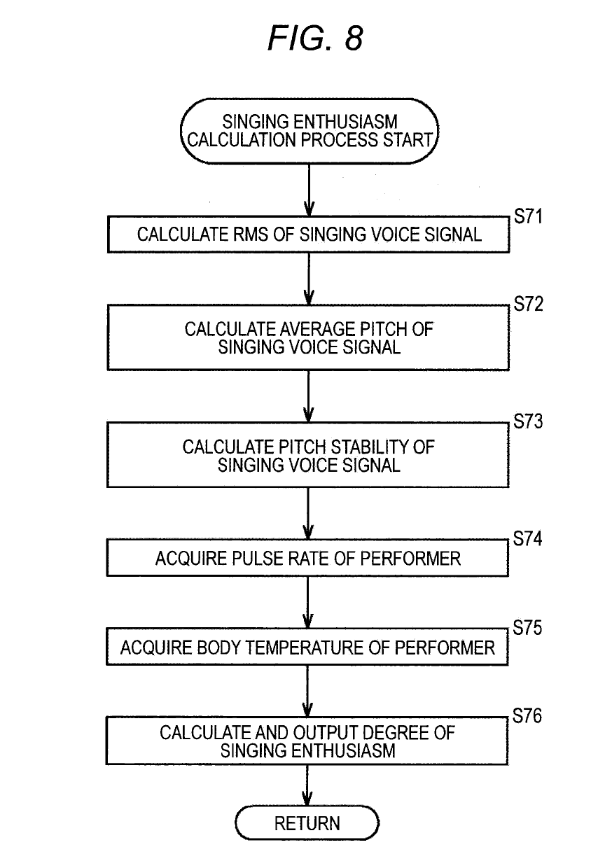

Referring now to the flowchart in FIG. 8, the singing enthusiasm calculation process is described.

In step S71, the singing enthusiasm calculating unit 51 calculates the RMS (Root Mean Square) of the singing voice signal at predetermined time intervals.

In step S72, the singing enthusiasm calculating unit 51 calculates the mean value of the fundamental frequency of the singing voice signal or a mean pitch value at predetermined time intervals.

In step S73, the singing enthusiasm calculating unit 51 calculates the reciprocal of the standard deviation of the fundamental frequency of the singing voice signal as the stability of the singing voice signal or a degree of pitch stability at predetermined time intervals.

In step S74, the singing enthusiasm calculating unit 51 acquires the information about the performer's pulse rate measured by the sensor 36a of the microphone 36.

In step S75, the singing enthusiasm calculating unit 51 acquires the information about the performer's body temperature measured by the sensor 36b of the microphone 36.

In step S76, the singing enthusiasm calculating unit 51 calculates a degree of singing enthusiasm according to the following equation (1), stores the calculated degree of singing enthusiasm into the storage unit 51a, and supplies the calculated degree of singing enthusiasm to the harmonizing signal controlling unit 56.

HS=α×RMS+β×mean pitch value+γ×pitch stability+δ×pulse rate+ε×body temperature (1)

Here, HS represents the degree of singing enthusiasm, RMS represents the root mean square of the singing voice signal, and α, β, γ, δ, and ε represent the weight coefficients of the respective parameters.

That is, the degree of singing enthusiasm becomes higher, as the respective parameters, which are the sound pressure level represented by the root mean square of the singing voice signal, the mean pitch value as the mean value of the fundamental frequency, the degree of pitch stability as the stability of the fundamental frequency, the pulse rate, and the body temperature, become higher. The degree of singing enthusiasm defined by the equation (1) is merely an example, and may be defined in a different manner. For example, in a case where the microphone 36 is a conventional microphone that does not have the sensors 36a and 36b, biological information such as the pulse rate and the body temperature of the performer may not be used as parameters. The biological information may further include blood pressure or the like. Furthermore, the weight coefficients α, β, γ, δ, and ε may be arbitrarily set.

Through the above process, a degree of singing enthusiasm can be calculated based on the singing voice signal of the performer and biological information about the performer.

Explanation now returns to the flowchart in FIG. 7.

After the degree of singing enthusiasm is calculated through the singing enthusiasm calculation process in step S44, the musical excitement calculating unit 55 in step S45 performs a musical excitement calculation process, and calculates a degree of musical excitement from the digital audio signal of the music data supplied from the MIDI sound source unit 29.

[Musical Excitement Calculation Process]

Referring now to the flowchart in FIG. 8, the musical excitement calculation process is described.

In step S91, the musical excitement calculating unit 55 calculates the RMS of the singing voice signal at predetermined time intervals, and cumulatively stores the RMS.

In step S92, the musical excitement calculating unit 55 calculates the mean value of the past RMSs stored prior to the calculations of the RMSs of the singing voice signal at predetermined intervals in the latest step.

In step S93, the musical excitement calculating unit 55 calculates a degree of musical excitement that is the difference between the mean value of the RMSs calculated in the latest step and the mean value of the RMSs, and supplies the degree of musical excitement to the harmonizing signal controlling unit 56.

Through the above described process, the difference between the mean value of the RMSs calculated at predetermined time intervals and the mean value of the past RMSs is set as the degree of musical excitement. The degree of musical excitement is calculated not necessarily by the above described technique, but may be determined by detecting the so-called “hook-line”, which is the exciting part of a tune, and calculating a value indicating the level of the hook-line.

Explanation now returns to the flowchart in FIG. 7.

After the degree of musical excitement is calculated through the musical excitement calculation process in step S45, the process moves on to step S46.

In step S46, the harmonizing voice signal gain adjusting unit 72 adjusts the gain of the harmonizing voice signal supplied from the pitch shifter 54, and supplies the resultant signal to the adder 73.

In step S47, the singing voice signal gain adjusting unit 71 adjusts the gain of the singing voice signal supplied from the A/D converter 34, and supplies the resultant signal to the adder 73 and the terminal 74a.

In step S48, the singing enthusiasm threshold determining unit 75 compares the degree of singing enthusiasm supplied from the singing enthusiasm calculating unit 51 with the singing enthusiasm threshold value that has been downloaded from the singing enthusiasm server 2 and been stored, and determines whether the degree of singing enthusiasm is higher than the singing enthusiasm threshold value. In a case where the degree of singing enthusiasm is determined to be higher than the singing enthusiasm threshold value in step S48, for example, the singing enthusiasm threshold determining unit 75 supplies the determination result to the output sound selecting unit 76, and the process then moves on to step S49.

In step S49, the musical excitement threshold determining unit 77 compares the degree of musical excitement supplied from the musical excitement calculating unit 55 with a predetermined musical excitement threshold value, and determines whether the degree of musical excitement is higher than the predetermined musical excitement threshold value. In a case where the degree of musical excitement is determined to be higher than the predetermined musical excitement threshold value in step S49, for example, the musical excitement threshold determining unit 77 supplies the determination result to the output sound selecting unit 76, and the process then moves on to step S50.

In step S50, the output sound selecting unit 76 connects the switch 74 to the terminal 74b based on the determination results supplied from the singing enthusiasm threshold determining unit 75 and the musical excitement threshold determining unit 77. As a result, the signal formed by combining the singing voice signal and the harmonizing voice signal by the adder 73 is supplied to the output sound selecting unit 76 via the terminal 74b, and the output sound selecting unit 76 then supplies the supplied combined signal generated by combining the singing voice signal and the harmonizing voice signal to the echo effect adding unit 57.

In step S51, the echo effect adding unit 57 adds a predetermined echo effect to the combined singing voice signal generated by combining the singing voice signal and the harmonizing voice signal, and outputs the resultant signal to the adder 58.

In step S52, the adder 58 combines the combined singing voice signal having the echo effect added thereto and the digital signal of the tune supplied from the MIDI sound source unit 29, and outputs the resultant signal to the D/A converter 31. Through this step, the combined singing voice signal combined with the digital signal of the tune is converted into an analog signal by the D/A converter 31, is subjected to gain adjustment by the amplifier 32, and is output through the speaker 33.

In a case where the degree of singing enthusiasm is determined to be lower than the singing enthusiasm threshold value in step S48, on the other hand, the singing enthusiasm threshold determining unit 75 supplies the determination result to the output sound selecting unit 76, and the process then moves on to step S53. Also, in a case where the degree of musical excitement is determined to be lower than the predetermined musical excitement threshold value in step S49, the musical excitement threshold determining unit 77 supplies the determination result to the output sound selecting unit 76, and the process then moves on to step S53.

In step S53, the output sound selecting unit 76 connects the switch 74 to the terminal 74a based on the determination results supplied from the singing enthusiasm threshold determining unit 75 and the musical excitement threshold determining unit 77. Only the singing voice signal is then supplied to the output sound selecting unit 76 via the terminal 74a, and the output sound selecting unit 76 supplies only the supplied singing voice signal to the echo effect adding unit 57.

That is, in a case where the degree of singing enthusiasm is higher than the singing enthusiasm threshold value, and the degree of musical excitement is higher than the musical excitement threshold value, the singing voice signal is combined with the harmonizing voice signal or the harmonizing function is switched on, and the singing voice signal is output together with the sound of the tune. In this manner, a harmonizing voice is added to the singing voice signal of the performer in accordance with the degree of singing enthusiasm that varies with the way of singing of the performer and the degree of musical excitement of the tune. Accordingly, harmonizing periods can be appropriately set, and a harmonizing voice or a consonant sound can be added. As a result, the performer does not need to mind when to switch on the harmonizing function, and the harmonizing function can be appropriately switched on. Accordingly, when using a karaoke machine, each performer can concentrate on singing.

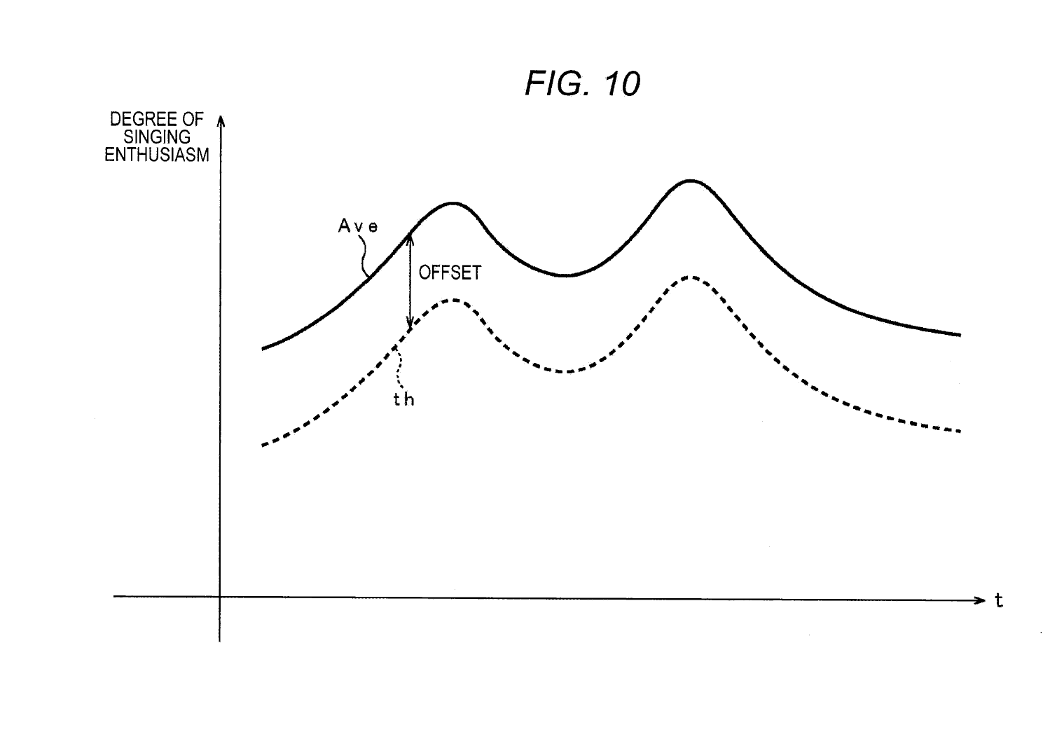

As shown in FIG. 10, the singing enthusiasm threshold value th is set at a value that is offset by a predetermined level with respect to the average degree of singing enthusiasm Ave of the same tune uploaded from a voice processing apparatus 1 in the network 4, for example. Although the degree of singing enthusiasm varies with the way of singing of each performer, the singing enthusiasm threshold value th is set at a value that is offset for performers that cannot reach the average degree of singing enthusiasm. Accordingly, a larger number of performers can use the harmonizing function when appropriate, even though the degree of singing enthusiasm varies with the way of singing of each performer. The singing enthusiasm threshold value th is a value that is offset with respect to the average degree of singing enthusiasm so as to facilitate switching on of the harmonizing function, as described above. Therefore, the offset value may be arbitrarily set, and may be zero so as to set the average degree of singing enthusiasm as the average degree of singing enthusiasm, for example.

In the above described example, each voice processing apparatus 1 uploads the information about a degree of singing enthusiasm to the singing enthusiasm server 2 via the network 4, and the singing enthusiasm threshold value determined from the average value of the degree of singing enthusiasm is downloaded and used. In this manner, an appropriate singing enthusiasm threshold value that reflects the intention of each performer with higher precision can be set. However, after a degree of singing enthusiasm that is close to the average is calculated, the variation of the singing enthusiasm threshold value is expected to become smaller. In view of this, a singing enthusiasm threshold value may not be downloaded from the singing enthusiasm server 2 each time. Instead, a singing enthusiasm threshold value may be downloaded and stored into each voice processing apparatus 1, and be repeatedly used thereafter. Alternatively, a singing enthusiasm threshold value may be stored beforehand into each apparatus at the time of shipment from the factory or the like, and be used thereafter. Further, degrees of singing enthusiasm of performers singing the same tune may be accumulated in one voice processing apparatus 1 instead of being transmitted via the network 4, and the singing enthusiasm threshold value may be determined from the average value of the degree of singing enthusiasm.

Although the singing enthusiasm server 2 exists in the network 4 in the above described example, the singing enthusiasm server 2 may be replaced by information processing apparatuses or servers that perform so-called cloud computing. In that case, the cloud computing may be performed only by the voice processing apparatuses 1 or karaoke machines.

In the above described example, a singing voice of each performer is used as a reference, and a consonant sound or a harmonizing voice is superimposed on the singing voice. However, a reference sound may not be a singing voice, and may be a sound of a musical instrument that is being played.

As described above, according to the present technique, a harmonizing sound or a so-called harmonizing voice can be added to a singing voice when appropriate for each tune or the singing manner of each performer in each voice processing apparatus formed with a music reproducing apparatus such as a so-called karaoke machine. In that case, a performer does not need to pay attention to harmonizing periods (timing), and accordingly, can concentrate on singing. In addition to that, a harmonizing voice can be added by the harmonizing function. Thus, each performer can enjoy singing with more comfort.

The above described series of processes can be performed by hardware, and can also be performed by software. When the series of processes are to be performed by software, the programs forming the software are installed into a computer. Here, the computer may be a computer incorporated into special-purpose hardware, or may be a general-purpose personal computer that can execute various kinds of functions as various kinds of programs are installed thereinto.

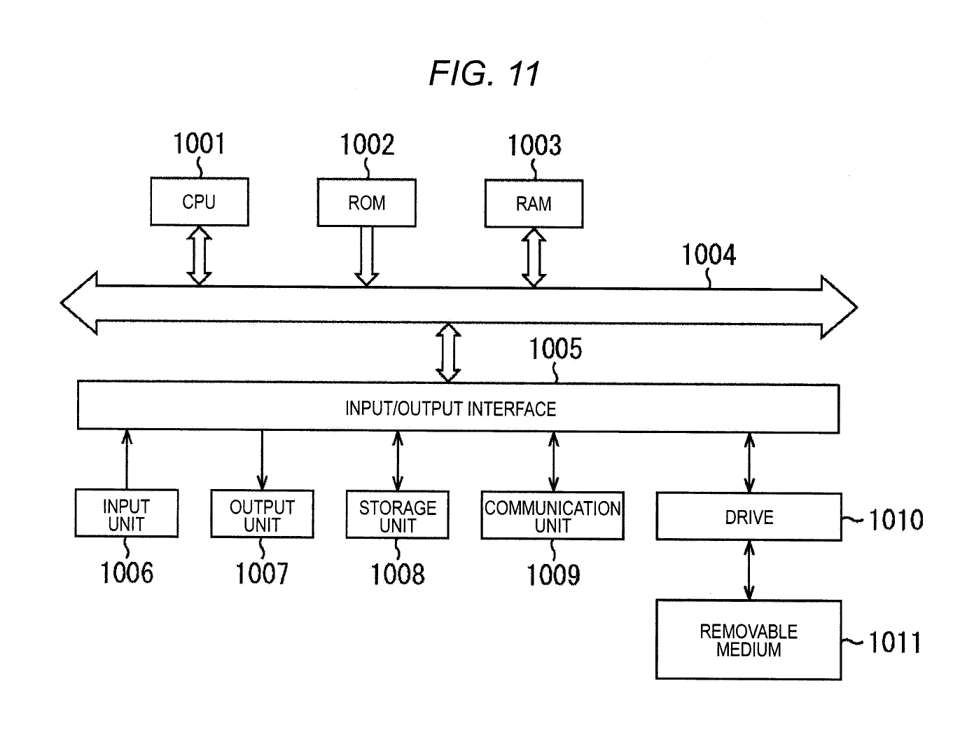

FIG. 11 is a block diagram showing an example structure of the hardware of a computer that performs the above described series of processes in accordance with programs.

In the computer, a CPU (Central Processing Unit) 1001, a ROM (Read Only Memory) 1002, and a RAM (Random Access Memory) 1003 are connected to one another by a bus 1004.

An input/output interface 1005 is further connected to the bus 1004. An input unit 1006, an output unit 1007, a storage unit 1008, a communication unit 1009, and a drive 1010 are connected to the input/output interface 1005.

The input unit 1006 is formed with a keyboard, a mouse, a microphone, and the like. The output unit 1007 is formed with a display, a speaker, and the like. The storage unit 1008 is formed with a hard disk, a nonvolatile memory, or the like. The communication unit 1009 is formed with a network interface or the like. The drive 1010 drives a removable medium 1011 such as a magnetic disk, an optical disk, a magnetooptical disk, or a semiconductor memory.

In the computer having the above described structure, the CPU 1001 loads the programs stored in the storage unit 1008 into the RAM 1003 via the input/output interface 1005 and the bus 1004, and executes the programs, so that the above described series of processes are performed.

The programs to be executed by the computer (the CPU 1001) may be recorded on the removable medium 1011 as a package medium to be provided, for example. Alternatively, the programs can be provided via a wired or wireless transmission medium such as a local area network, the Internet, or digital satellite broadcasting.

In the computer, the programs can be installed into the storage unit 1008 via the input/output interface 1005 when the removable medium 1011 is mounted on the drive 1010. Also, the programs may be received by the communication unit 1009 via a wired or wireless transmission medium, and be installed into the storage unit 1008. Alternatively, the programs may be installed beforehand into the ROM 1002 or the storage unit 1008.

The programs to be executed by the computer may be programs for performing processes in chronological order in accordance with the sequence described in this specification, or may be programs for performing processes in parallel or performing a process when necessary, such as when there is a call.

In this specification, a system means an assembly of components (apparatuses, modules (parts), and the like), and not all the components need to be provided in the same housing. In view of this, apparatuses that are housed in different housings and are connected to each other via a network form a system, and one apparatus having modules housed in one housing is also a system.

It should be noted that embodiments of the present technique are not limited to the above described embodiments, and various modifications may be made to them without departing from the scope of the present technique.

For example, the present technique can be embodied in a cloud computing structure in which one function is shared among apparatuses via a network, and processing is performed by the apparatuses cooperating with one another.

The respective steps described with reference to the above described flowcharts can be carried out by one apparatus or can be shared among apparatuses.

In a case where more than one process is included in one step, the processes included in the step can be performed by one apparatus or can be shared among apparatuses.

The present technique can also be in the following forms.

(1) A signal processing apparatus including:

a singing enthusiasm calculating unit that calculates a degree of singing enthusiasm formed with a feature quantity indicating the status of singing enthusiasm of a performer of a tune;

a harmonizing voice signal superimposition determining unit that determines whether to superimpose a harmonizing voice signal on a singing voice signal of the performer of the tune based on the degree of singing enthusiasm calculated by the singing enthusiasm calculating unit; and

a harmonizing voice signal superimposing unit that superimposes the harmonizing voice signal on the singing voice signal based on a result of the determination performed by the harmonizing voice signal superimposition determining unit.

(2) The signal processing apparatus of (1), wherein the singing enthusiasm calculating unit calculates the degree of singing enthusiasm formed with the feature quantity indicating the status of singing enthusiasm of the performer based on a singing voice signal of the performer of the tune.
(3) The signal processing apparatus of (1) or (2), further including

a biological information acquiring unit that acquires biological information about the performer,

wherein the singing enthusiasm calculating unit calculates the degree of singing enthusiasm formed with the feature quantity indicating the status of singing enthusiasm of the performer based on the biological information about the performer of the tune.

(4) The signal processing apparatus of any of (1) through (3), wherein the harmonizing voice signal superimposition determining unit determines whether to superimpose the harmonizing voice signal on the singing voice signal of the performer of the tune by comparing the degree of singing enthusiasm calculated by the singing enthusiasm calculating unit with a singing enthusiasm threshold value that is set with respect to the degree of singing enthusiasm, and determines that the harmonizing voice signal is to be superimposed on the singing voice signal of the performer of the tune when the degree of singing enthusiasm is higher than the singing enthusiasm threshold value.
(5) The signal processing apparatus of any of (1) through (4), further including

an excitement calculating unit that calculates a degree of excitement of the tune based on a music audio signal that is the audio signal of the tune,

wherein the harmonizing voice signal superimposition determining unit determines whether to superimpose the harmonizing voice signal on the singing voice signal based on the degree of singing enthusiasm calculated by the singing enthusiasm calculating unit and the degree of excitement calculated by the excitement calculating unit.

(6) The signal processing apparatus of any of (1) through (5), wherein

the singing enthusiasm threshold calculating unit calculates a singing enthusiasm threshold value by using the average value of degrees of singing enthusiasm of performers, and

the harmonizing voice signal superimposition determining unit determines whether to superimpose the harmonizing voice signal on the singing voice signal of the performer of the tune by comparing the degree of singing enthusiasm calculated by the singing enthusiasm calculating unit with the singing enthusiasm threshold value that is set with respect to the degree of singing enthusiasm and is determined by using the average value of the degrees of singing enthusiasm of the performers, and determines that the harmonizing voice signal is to be superimposed on the singing voice signal of the performer of the tune when the degree of singing enthusiasm is higher than the singing enthusiasm threshold value.

(7) A signal processing system including:

an information processing apparatus that includes:

a singing enthusiasm acquiring unit that acquires degrees of singing enthusiasm calculated by singing enthusiasm calculating units from signal processing apparatuses of any of (1) through (6) via a network, the signal processing apparatuses including the singing enthusiasm calculating units that calculate the degrees of singing enthusiasm;

a singing enthusiasm threshold calculating unit that calculates a singing enthusiasm threshold value by using the average value of the degrees of singing enthusiasm obtained by the singing enthusiasm acquiring unit from the signal processing apparatuses; and

a delivering unit that delivers the singing enthusiasm threshold value calculated by the singing enthusiasm threshold calculating unit to the signal processing apparatuses; and

a signal processing apparatus of any of (1) through (6),

wherein the harmonizing voice signal superimposition determining unit determines whether to superimpose the harmonizing voice signal on the singing voice signal of the performer of the tune by comparing the degree of singing enthusiasm calculated by the singing enthusiasm calculating unit with the singing enthusiasm threshold value that is set with respect to the degree of singing enthusiasm and is delivered from the delivering unit, and determines that the harmonizing voice signal is to be superimposed on the singing voice signal of the performer of the tune when the degree of singing enthusiasm is higher than the singing enthusiasm threshold value.

(8) A signal processing method including:

a singing enthusiasm calculating step of calculating a degree of singing enthusiasm formed with a feature quantity indicating the status of singing enthusiasm of a performer of a tune, the singing enthusiasm calculating step being carried out at a singing enthusiasm calculating unit that calculates the degree of singing enthusiasm formed with the feature quantity indicating the status of singing enthusiasm of the performer of the tune;

a harmonizing voice signal superimposition determining step of determining whether to superimpose a harmonizing voice signal on a singing voice signal of the performer of the tune based on the degree of singing enthusiasm calculated by the processing in the singing enthusiasm calculating step, the harmonizing voice signal superimposition determining step being carried out at a harmonizing voice signal superimposition determining unit that determines whether to superimpose the harmonizing voice signal on the singing voice signal of the performer of the tune based on the degree of singing enthusiasm calculated by the singing enthusiasm calculating unit; and

a harmonizing voice signal superimposing step of superimposing the harmonizing voice signal on the singing voice signal based on a result of the determination performed by the processing in the harmonizing voice signal superimposition determining step, the harmonizing voice signal superimposing step being carried out at a harmonizing voice signal superimposing unit that superimposes the harmonizing voice signal on the singing voice signal based on a result of the determination performed by the harmonizing voice signal superimposition determining unit.

(9) A program for causing a computer to perform an operation that includes:

a singing enthusiasm calculating step of calculating a degree of singing enthusiasm formed with a feature quantity indicating the status of singing enthusiasm of a performer of a tune, the singing enthusiasm calculating step being carried out at a singing enthusiasm calculating unit;

a harmonizing voice signal superimposition determining step of determining whether to superimpose a harmonizing voice signal on a singing voice signal of the performer of the tune based on the degree of singing enthusiasm calculated by the processing in the singing enthusiasm calculating step, the harmonizing voice signal superimposition determining step being carried out at a harmonizing voice signal superimposition determining unit; and

a harmonizing voice signal superimposing step of superimposing the harmonizing voice signal on the singing voice signal based on a result of the determination performed by the processing in the harmonizing voice signal superimposition determining step, the harmonizing voice signal superimposing step being carried out at a harmonizing voice signal superimposing unit,

the computer controlling a signal processing apparatus that includes:

the singing enthusiasm calculating unit that calculates the degree of singing enthusiasm formed with the feature quantity indicating the status of singing enthusiasm of the performer of the tune;

the harmonizing voice signal superimposition determining unit that determines whether to superimpose the harmonizing voice signal on the singing voice signal of the performer of the tune based on the degree of singing enthusiasm calculated by the singing enthusiasm calculating unit; and

the harmonizing voice signal superimposing unit that superimposes the harmonizing voice signal on the singing voice signal based on a result of the determination performed by the harmonizing voice signal superimposition determining unit.

### REFERENCE SIGNS LIST

1, 1-1 through 1-n Voice processing apparatus, 2 Singing enthusiasm server, 3 Music database, 4 Network, 30 DSP, 51 Singing enthusiasm calculating unit, 52 Pitch detecting unit, 53 Harmonizing key determining unit, 54 Pitch shifter, 55 Musical excitement calculating unit, 56 Harmonizing signal controlling unit, 57 Echo effect adding unit, 58 Adder

1. A signal processing apparatus comprising:
a singing enthusiasm calculating unit configured to calculate a degree of singing enthusiasm formed with a feature quantity indicating a status of singing enthusiasm of a performer of a tune;
a harmonizing voice signal superimposition determining unit configured to determine whether to superimpose a harmonizing voice signal on a singing voice signal of the performer of the tune based on the degree of singing enthusiasm calculated by the singing enthusiasm calculating unit; and
a harmonizing voice signal superimposing unit configured to superimpose the harmonizing voice signal on the singing voice signal based on a result of the determination performed by the harmonizing voice signal superimposition determining unit.

2. The signal processing apparatus according to claim 1, wherein the singing enthusiasm calculating unit calculates the degree of singing enthusiasm formed with the feature quantity indicating the status of singing enthusiasm of the performer based on a singing voice signal of the performer of the tune.

3. The signal processing apparatus according to claim 1, further comprising
a biological information acquiring unit configured to acquire biological information about the performer,
wherein the singing enthusiasm calculating unit calculates the degree of singing enthusiasm formed with the feature quantity indicating the status of singing enthusiasm of the performer based on the biological information about the performer of the tune.

4. The signal processing apparatus according to claim 1, wherein the harmonizing voice signal superimposition determining unit determines whether to superimpose the harmonizing voice signal on the singing voice signal of the performer of the tune by comparing the degree of singing enthusiasm calculated by the singing enthusiasm calculating unit with a singing enthusiasm threshold value that is set with respect to the degree of singing enthusiasm, and determines that the harmonizing voice signal is to be superimposed on the singing voice signal of the performer of the tune when the degree of singing enthusiasm is higher than the singing enthusiasm threshold value.

5. The signal processing apparatus according to claim 1, further comprising
an excitement calculating unit configured to calculate a degree of excitement of the tune based on a music audio signal that is an audio signal of the tune,
wherein the harmonizing voice signal superimposition determining unit determines whether to superimpose the harmonizing voice signal on the singing voice signal based on the degree of singing enthusiasm calculated by the singing enthusiasm calculating unit and the degree of excitement calculated by the excitement calculating unit.

6. The signal processing apparatus according to claim 1, wherein
the singing enthusiasm threshold calculating unit calculates a singing enthusiasm threshold value by using an average value of degrees of singing enthusiasm of a plurality of performers, and
the harmonizing voice signal superimposition determining unit determines whether to superimpose the harmonizing voice signal on the singing voice signal of the performer of the tune by comparing the degree of singing enthusiasm calculated by the singing enthusiasm calculating unit with the singing enthusiasm threshold value that is set with respect to the degree of singing enthusiasm and is determined by using the average value of the degrees of singing enthusiasm of the plurality of performers, and determines that the harmonizing voice signal is to be superimposed on the singing voice signal of the performer of the tune when the degree of singing enthusiasm is higher than the singing enthusiasm threshold value.

7. A signal processing system comprising:
an information processing apparatus including:
a singing enthusiasm acquiring unit configured to acquire degrees of singing enthusiasm calculated by singing enthusiasm calculating units from a plurality of signal processing apparatuses of claim 1 via a network, the signal processing apparatuses including the singing enthusiasm calculating units configured to calculate the degrees of singing enthusiasm;
a singing enthusiasm threshold calculating unit configured to calculate a singing enthusiasm threshold value by using an average value of the degrees of singing enthusiasm obtained by the singing enthusiasm acquiring unit from the plurality of signal processing apparatuses; and
a delivering unit configured to deliver the singing enthusiasm threshold value calculated by the singing enthusiasm threshold calculating unit to the plurality of signal processing apparatuses; and
a signal processing apparatus of claim 1,
wherein the harmonizing voice signal superimposition determining unit determines whether to superimpose the harmonizing voice signal on the singing voice signal of the performer of the tune by comparing the degree of singing enthusiasm calculated by the singing enthusiasm calculating unit with the singing enthusiasm threshold value that is set with respect to the degree of singing enthusiasm and is delivered from the delivering unit, and determines that the harmonizing voice signal is to be superimposed on the singing voice signal of the performer of the tune when the degree of singing enthusiasm is higher than the singing enthusiasm threshold value.

8. A signal processing method comprising:
a singing enthusiasm calculating step of calculating a degree of singing enthusiasm formed with a feature quantity indicating a status of singing enthusiasm of a performer of a tune, the singing enthusiasm calculating step being carried out at a singing enthusiasm calculating unit configured to calculate the degree of singing enthusiasm formed with the feature quantity indicating the status of singing enthusiasm of the performer of the tune;
a harmonizing voice signal superimposition determining step of determining whether to superimpose a harmonizing voice signal on a singing voice signal of the performer of the tune based on the degree of singing enthusiasm calculated by the processing in the singing enthusiasm calculating step, the harmonizing voice signal superimposition determining step being carried out at a harmonizing voice signal superimposition determining unit configured to determine whether to superimpose the harmonizing voice signal on the singing voice signal of the performer of the tune based on the degree of singing enthusiasm calculated by the singing enthusiasm calculating unit; and
a harmonizing voice signal superimposing step of superimposing the harmonizing voice signal on the singing voice signal based on a result of the determination performed by the processing in the harmonizing voice signal superimposition determining step, the harmonizing voice signal superimposing step being carried out at a harmonizing voice signal superimposing unit configured to superimpose the harmonizing voice signal on the singing voice signal based on a result of the determination performed by the harmonizing voice signal superimposition determining unit.

9. A program for causing a computer to perform an operation including:
a singing enthusiasm calculating step of calculating a degree of singing enthusiasm formed with a feature quantity indicating a status of singing enthusiasm of a performer of a tune, the singing enthusiasm calculating step being carried out at a singing enthusiasm calculating unit;
a harmonizing voice signal superimposition determining step of determining whether to superimpose a harmonizing voice signal on a singing voice signal of the performer of the tune based on the degree of singing enthusiasm calculated by the processing in the singing enthusiasm calculating step, the harmonizing voice signal superimposition determining step being carried out at a harmonizing voice signal superimposition determining unit; and
a harmonizing voice signal superimposing step of superimposing the harmonizing voice signal on the singing voice signal based on a result of the determination performed by the processing in the harmonizing voice signal superimposition determining step, the harmonizing voice signal superimposing step being carried out at a harmonizing voice signal superimposing unit,
the computer controlling a signal processing apparatus including:
the singing enthusiasm calculating unit configured to calculate the degree of singing enthusiasm formed with the feature quantity indicating the status of singing enthusiasm of the performer of the tune;
the harmonizing voice signal superimposition determining unit configured to determine whether to superimpose the harmonizing voice signal on the singing voice signal of the performer of the tune based on the degree of singing enthusiasm calculated by the singing enthusiasm calculating unit; and
the harmonizing voice signal superimposing unit configured to superimpose the harmonizing voice signal on the singing voice signal based on a result of the determination performed by the harmonizing voice signal superimposition determining unit.
